(19) United States
(12) Patent Application Publication
(10) Pub. No.: US 2015/0170232 A1
(43) Pub. Date: Jun. 18, 2015

(54) METHOD AND APPARATUS FOR EXCHANGING MEDIA ASSETS

(71) Applicant: THOMSON LICENSING, Issy de Moulineaux (FR)

(72) Inventor: Patrick Sean GILDEA, La Canada, CA (US)

(21) Appl. No.: 14/573,919

(22) Filed: Dec. 17, 2014

Related U.S. Application Data
(60) Provisional application No. 61/917,549, filed on Dec. 18, 2013.

(51) Int. Cl. G06Q 30/06; H04L 29/06; H04L 29/08

(52) U.S. Cl. CPC G06Q 30/0601; H04L 67/06; H04L 67/42

(57) ABSTRACT

In response to received transaction data for the purchase or rental of a first media asset that has been previously rented/purchased, a user is given an option to exchange the first media asset with a second media asset. The restriction being placed on the user's selection is that the first and second media assets are from the same class. The same class can be one of where the second media asset is a sequel of the first media asset, remake of the first media asset, from the same television series as the first media asset, from the same movie series of the first media asset, from the same content creator of the first media asset, and video game series of the first media asset. The second media asset is then consumed by the user in the form of a purchase or rental.

### CROSS REFERENCE TO RELATED APPLICATIONS

This application claims priority from U.S. Provisional Application No. 61/917,549, filed on Dec. 18, 2013.

### TECHNICAL FIELD

The disclosure is related towards a method and apparatus for purchasing or renting media assets, and more particularly to a method and apparatus for exchanging a first media asset for a second media asset when the first media asset has been previously purchased or rented.

### BACKGROUND

When a user purchases a media asset such a television show, movie, music, video game, and the like, the user may not realize that they have previously purchased or rented such a media asset. In such cases, a user can return a media asset to a physical store or mail order store if that media asset is in a physical form as a Compact Disc (CD), Blu Ray Disc, Digital Versatile Disc (DVD), Gift Card version of the media asset, and the like. A return of a media asset however becomes difficult if the media asset is in a digital form that is streamed over a network connection from a media asset provider such as AMAZON, ITUNES, M-GO, VUDU, and the like because there is nothing physical to return when a media asset is in a digital form.

Moreover, another situation exists when a digital media asset is purchased as a gift for a person where the person has previously rented or purchased such the digital media asset for themselves. A media asset provider is unlikely to want to refund the money for the purchase price of the digital media asset. It is also unlikely that the content creator who is responsible for the creation of the digital media asset would want to lose the revenues generated from the purchase or rental of the digital asset.

Thus, there a method and apparatus are needed to preserve the revenues obtained for a previously purchased or rented digital media asset while satisfying the needs of a user who wants to consume a new digital media asset.

### BRIEF SUMMARY

One embodiment of the disclosure describes a method and apparatus for exchanging a purchased or rented media asset. In response to received transaction data for the purchase or rental of a first media asset that has been previously purchased/rented, a user is given an option to exchange the first media asset with a second media asset. The restriction being placed on the user's selection is that the first and second media assets are from the same class. The same class can be one of where the second media asset is a sequel of the first media asset, remake of the first media asset, from the same television series as the first media asset, from the same movie series of the first media asset, from the same content creator of the first media asset, and from the same video game series of the first media asset. The second media asset is then consumed by the user in the form of a purchase or rental.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering content to a user in accordance with the principles of the present disclosure;

FIG. 2 shows a block diagram of an embodiment of a server in accordance with the principles of the present disclosure;

FIG. 3 shows a block diagram of an embodiment of a playback device in accordance with the principles of the present disclosure;

FIG. 4 presents a flow chart of an embodiment that provides a user with the option of exchanging a first media asset for a second media asset in accordance with the principles of the present disclosure;

FIG. 5 presents a user interface displaying an option to exchange a previously rented first media asset with a media asset that is a sequel of the first media asset in accordance with the exemplary principles of the present disclosure;

FIG. 6 presents a user interface displaying an option to exchange a previously rented first media asset with a media asset that is a remake of the first media asset in accordance with the exemplary principles of the present disclosure;

FIG. 7 presents a user interface displaying an option to buy a second media asset as a replacement for a first media asset that has been previously rented or purchased in accordance with the exemplary principles of the present disclosure;

FIG. 8 presents a user interface displaying an option to rent a second media asset as a replacement for a first media asset that has been previously rented or purchased in accordance with the exemplary principles of the present disclosure;

FIG. 9 presents a user interface displaying an option to rent an alternative media asset as a replacement for a first media asset that has been previously rented or purchased in accordance with the exemplary principles of the present disclosure;

FIG. 10 presents a user interface displaying an option to replace a previously purchased first media asset with a second media asset that is a sequel of the first media asset in accordance with the exemplary principles of the present disclosure; and

FIG. 11 presents a user interface displaying an option to exchange a previously rented first media asset that was provided in a standard definition form with a version of the first media asset in a higher video quality format in accordance with the exemplary principles of the present disclosure.

It should be understood that the drawing(s) is for purposes of illustrating the concepts of the disclosure and is not necessarily the only possible configuration for illustrating the disclosure.

### DETAILED DESCRIPTION OF THE INVENTION

It should be understood that the elements shown in the Figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate instructions. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

Using inventive concepts, the principles discussed below present a scenario where media assets can be exchanged from a media asset content provider such as M-GO, NETFLIX, AMAZON, VUDU, and the like. Media assets can be in the form of a movie, television show, video, audio program, music, podcast, video game, and the like. A class of media assets can be one where two media assets are from the same television series, same movie series, the same video game series, a second media asset is a remake of a first media asset, a second media asset is a sequel of a first media asset, the media assets are from the same content creator, and the like.

A content creator is a movie studio, television studio, video creator, record company, video game company, broadcast network, and the like that create media assets. For example, Walt Disney Studios is a content creator that creates movies, television shows, video games, music, and the like. Time Warner is another example of a content creator that creates media assets as well through various divisions such as Time Warner Music, Warner Brothers Studios, and Warner Brothers Game Studios. Other examples of content creators are to be considered in accordance with these principles. The term content creator and content provider are used interchangeably within the specification.

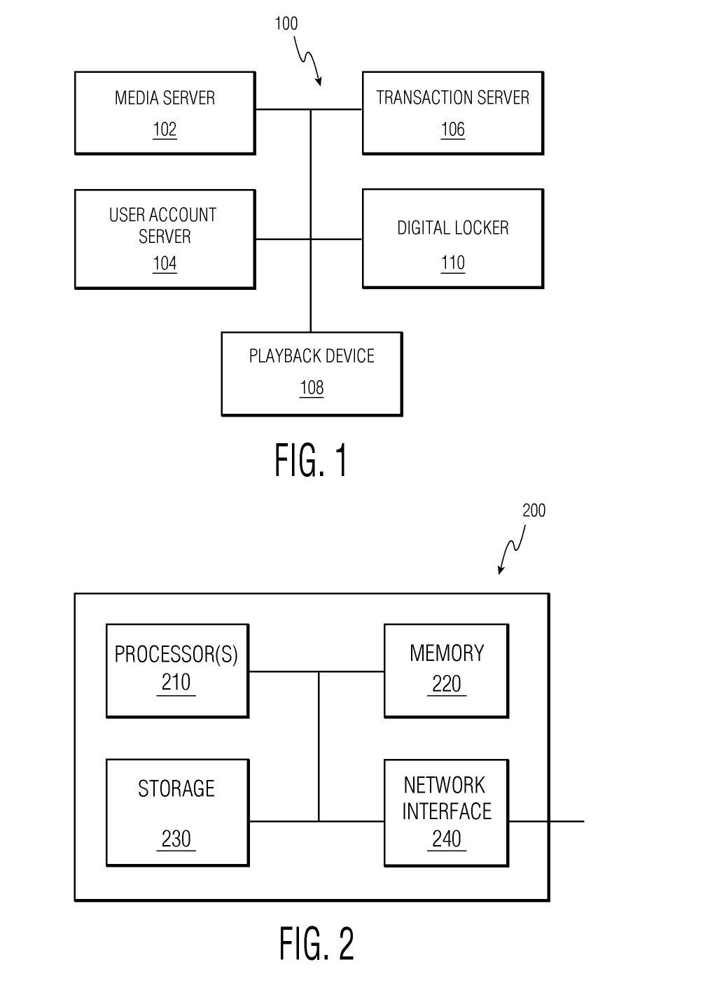

FIG. 1 shows a block diagram of an embodiment of a system 100 for delivering content to a user in accordance with the principles of the present disclosure where each of the display components are coupled to each other using a network connection, wired connection, wireless connection, and the like. Media server 102 is configured to supply media assets to playback device 108 when a user purchases or rents a media asset. The transactional data corresponding to when a user purchases or rents a media asset can come from transaction server 106 that provides a user with the ability to purchase/rent a media asset using payment information, Quick Response (QR) code, alphanumeric code, code from a gift card, and the like. Ideally, transaction server 106 will authorize the transmission of a media asset from media server 102 when the transaction for the media asset is accepted by transaction server 106.

Transactional data about a rental or purchase of a media asset can also be stored in user account server 104 that stores various user information about what media assets a user has rented and/or purchased in the past. Such transactional data can be provided by transaction server 106. User account server 104 can also be configured to store data about what media assets a user has stored in digital locker 110 as a result of a purchase. Digital locker 110 can be a server such as AMAZON CLOUD, GOGGLE PLAY, M-GO STORAGE LOCKER, DROPBOX, and the like where a user can have different media assets stored within the server or plurality of servers comprising digital locker 110. Optionally, a user can also store media assets that are ripped from various physical media such as a compact disc, DVD, Blu-Ray, and the like where the user obtains a digital version of the media asset from such a ripping operation.

Referring back to media server 102, a database can be implemented in the memory 220 or storage 230 (FIG. 2) of server 102 that stores different class information about different media assets. For example, the database can store information that indicates which media assets are sequels of each other, remakes of each other, from the same television series, from the same movie series, from the same content creator, from the same video game series, and the like. The database can also be configured to store information for a media asset about the different quality version of a media asset that are available which can be a standard definition version, a high definition version, a 4K version, an ultra-high definition version, and the like.

This database of media server 102 can also be further configured to make media server 102 into a media asset provider. That is, media server 102 will manage the purchase and delivery of media assets over a network using information from user account server 104 and transaction server 106.

In an optional embodiment, media server 102, user account server 104, transaction server 106, and digital locker 110 are all integrated into the same server or a plurality of servers in accordance with the described principles.

Playback device 108 can be configured to provide a user with the ability to select a media asset, purchase a media asset, and playback a media asset purchased from media server 102 and transactional server 108. That is, playback device 108 can manage user account operations, purchase operations, and playback operations through the use of a media asset provider. Playback device 108 can be a computer, video game system, display device, tablet, phone, smart watch, set top box, electronic book reader, digital audio music player, and the like.

FIG. 2 depicts an exemplary server 200 that can be used for implementing any one of the media server 102, user account server 104, transaction server 106, digital locker 110, and the like. The server, includes one or more processors 210, memory 220, storage 230, and a network interface 240. Each of these elements will be discussed in more detail below.

The processor 210 controls the operation of the server 200. The processor 210 runs the software that operates the server as well as provides the functionality of the software required to operate any one of the servers (102, 104, 106, 110). The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media. Memory 220 can be configured to operate a database to support any one of the operations required for servers (102, 104, 106, 110) in accordance with the described principles under the direction of processor 210.

The storage 230 is where data is stored for the use of processor 210 in executing the described operations. Storage 230 can be magnetic media (hard drive), optical media (CD/DVD-Rom), or flash based storage. Storage 230 can be configured to operate a database to support any of the operations required for server (102, 104, 106, 110) in accordance with the described principles under the direction of processor 210. Storage 230 can also be configured to store information comporting to user account data, transaction data, information comporting to previous media asset transactions by a user, media assets, and the like.

Network interface 240 handles the communication of server 200 with other devices over a network. Examples of suitable networks include Ethernet networks, Wi-Fi enabled networks, cellular networks, and the like. Other types of suitable networks will be apparent to one skilled in the art given the benefit of this disclosure.

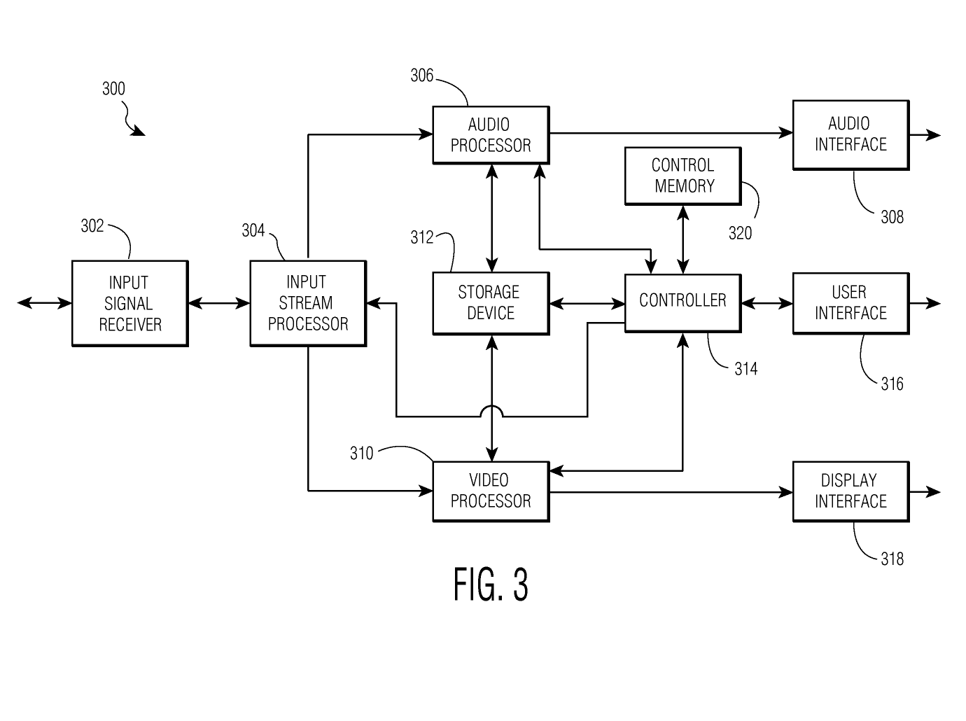

In the playback device 300 shown in FIG. 3, media assets are received in an input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

Storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI).

Controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

User interface 316 of the present disclosure can employ an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

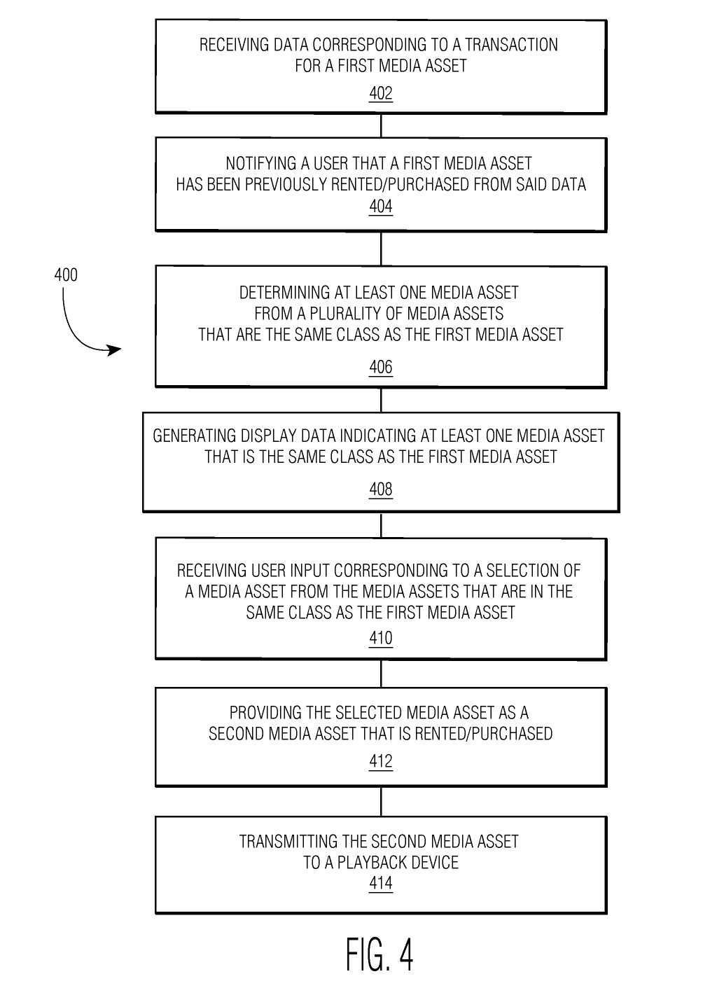

FIG. 4 presents a flow chart of 400 an embodiment that provides a user with the option of exchanging a first media asset for a second media asset in accordance with the principles of the present disclosure. In step 402, server 102 receives data corresponding to a transaction for a first media asset, such as a rental or purchase, for a user. In an embodiment of the described principles, transactional data come from server 106 to server 102 to describe the transaction. A user can purchase or rent a media asset from a media asset provider in accordance with the principles described herein.

In step 404, a user is notified that a first media asset has been previously purchased or rented. This step can be performed by having media server 102 query an internal database to determine what media assets have been purchased or rented by a particular user. The query operation of determining whether a user has previously rented or purchased media assets can also be performed by having media server 102 query user account server 104 or transaction server 106 to determine the previous transactions performed by a user.

If media server 102 determines that a user has previously purchased or rented a media asset, media server 102 will notify the user that this is the case and provide a user with the option of exchanging media asset for a second media asset. Such a notification can be performed by having media server 102 generate and transmit information to playback device 108 indicating that the media service was the subject of a previous transaction. If the media server 102 determines that the media asset is being purchased or rented for the first time, media server will end up transmitting the media asset to playback device 108 in accordance with the described principles.

In the case where the media asset has been previously purchased or rented, media server 102 continues with step 406 where a determination is made as to what class the first media asset belongs to by referencing a database in accordance with the described principles. The same database can be used to identify at least one media asset from a plurality of media assets as an alternative for the first media asset as long as the alternative media asset and the first media asset are from the same class. The use of a class limits the selection of alternative media assets to specific groups where a first media asset and the second (alternative) media asset that is used as the basis of the exchange share some common attribute as described in illustrative embodiments.

For example, a first media asset can be a movie that is 101 Dalmatians that was created and released by the Walt Disney company as a cartoon. If a user has previously purchased or rented 101 Dalmatians, media server 102 can determine alternative media assets that share the same class. For instance, 101 Dalmatians was remade as a live action movie starring Glenn Close where the “remake” serves as an example of the same class. 101 Dalmatians also has a sequel called 102 Dalmatians where the “sequel” operates as an example of a class. Movies such as Dumbo and Fantasia can also be used as alternative media assets for 101 Dalmatians as all of these movies were made by the same content creator, where “content creator” is an example of a class. Other implementations of these principles can be utilized in accordance with the described exemplary embodiments.

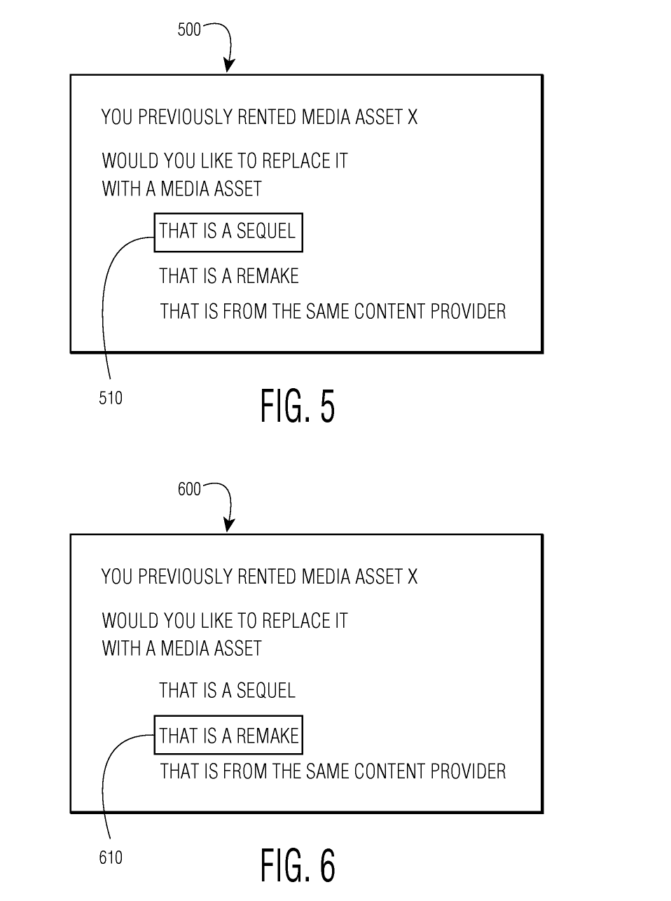

In step 408, media server 102 generates displayable data indicating at least one media asset that is the same class as the first media asset. This data can come from the result of step 406 where different media assets, as alternative media assets for a first media asset, are determined to be of the same class of the first media asset. Such generated displayable data can be transmitted to playback device 108 for a user to select a second media asset as an alternative for a first media asset, as long as both media assets are of the same class. Examples of such displayable data are shown in FIGS. 5-11 described below.

In an alternative version of step 408, a user is offered the option to select the rental or purchase of the first media asset in a higher quality format. For example, if the first media asset has been previously purchased or rented in a standard definition video format, a user can be notified that the user can purchase or rent the media asset in a high definition, 4K, ultra high definition video format, and the like. This determination is made based on the previous transactions of a user as made by media server 102.

In step 410, media server 102 receives user input data from playback device 108 that indicates a selection of an alternative media asset as a second media asset when the first and second media asset are in the same class. This selection information can come from a user's determination of what media asset to select as an alternative media asset options from step 408.

In step 412, the alternative (second) media asset is provided to a playback device 108 in the form of a purchase or a rental, in accordance with the described principles. Specifically, in step 414, the selected second media asset, as a digital media asset, is transmitted from media server 102 to playback device 108 over a network connection, although other transmission schemes can be used in accordance with the described principles. Optionally, the second media asset can be stored in digital locker 110 when purchased as a replacement for the first media asset.

FIG. 5 is an representation of a user interface 500 displaying an option to exchange a previously rented media asset with a media asset that is of the same class of the previously rented media asset. The information for generating any of the disclosed user interfaces can come from any of the servers (102, 104, 106, 110) and can be rendered on playback device 108 in response to such received information. In the present example, a user has the ability to select between three different classes of media assets using an indicator 510. The first class is representative of media assets that are sequels to the previously rented media asset, where the indicator is presently highlighting the sequel option. A second option, represents the class of remakes, where are media assets that are remakes of a previously rented media asset. A third class represents media assets that are from the same content provider/creator that created the previously rented media asset.

FIG. 6 is a representation of a user interface 600 displaying an option to exchange a previously rented media asset with a media asset that is of the same class of the previously rented media asset. In this example, the option to display media assets that are remakes of a previously rented media asset is highlighted using an indicator 610 in response to a user command. It is noted that other classes and options can be displayed in accordance with the disclosed principles.

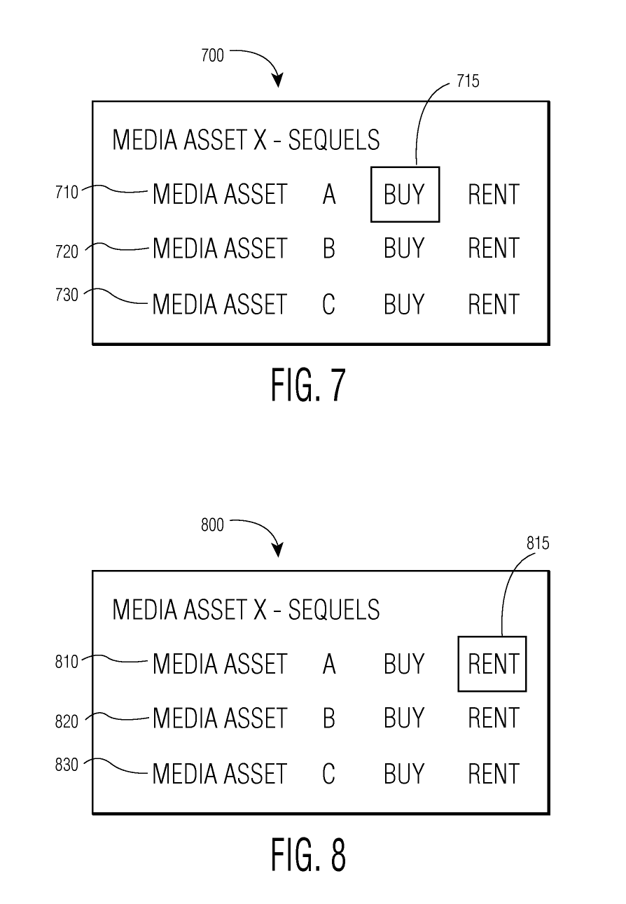

FIG. 7 discloses a user interface display 700 shows an option to buy a second media asset as a replacement for a first media asset that has been previously rented/purchased in accordance with the exemplary principles of the present disclosure. Specifically, the listing of media assets in user interface display 700 corresponds to the class of “sequels” of a first media asset known as media asset “x”. That is, media asset “a” 710, media asset “b” 720, and media asset “c” 730 are identified as being sequels of media asset x. Various options are then presented to either buy or rent alternative media assets 710, 720, 730. In the present example, an indicator 715 can be operated by a user to select the purchase of media asset “a” 710.

FIG. 8 discloses a user interface display 800 showing an option to buy a second media asset as a replacement for a first media asset that has been previously rented/purchased in accordance with the exemplary principles of the present disclosure. In this disclosed embodiment, media asset “a” 810 is selected with indicator 815 for a rental operation. Media asset “b” 820 and media asset “c” 830 are not selected in this example.

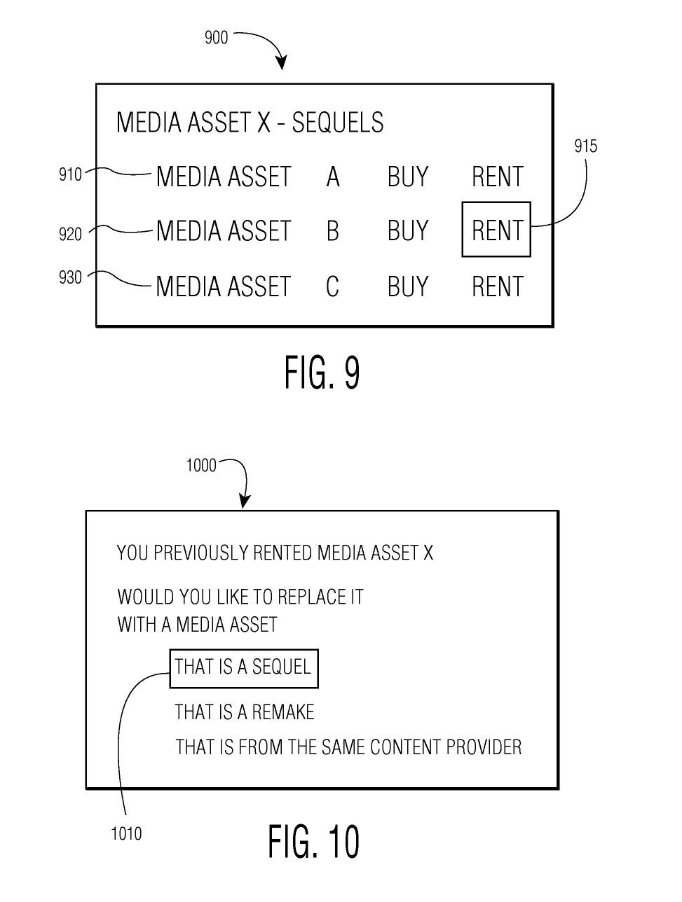

FIG. 9 discloses a user interface display 900 showing an option to rent a media asset as a replacement for a first media asset that has been previously rented/purchased. Specifically, in response to user input media asset “b” 920 is selected as a rental using indicator 915. Media assets “a” 910 and media asset “c” 930 are not selected in this example.

FIG. 10 presents a user interface display 1000 that presents an option to replace the purchase of a previously purchased media asset with a second media asset. In this example, a user is notified that a media asset “x” has been previously purchased. The user is then provided with different options of different classes of media assets which can be selected from in order to exchange the purchase of media asset “x” to another media asset. In this example, indicator 1010 is used to select from the class related to sequels. The classes that are not selected in this example are remakes of media asset “x” and same content provider as that of media asset “x”.

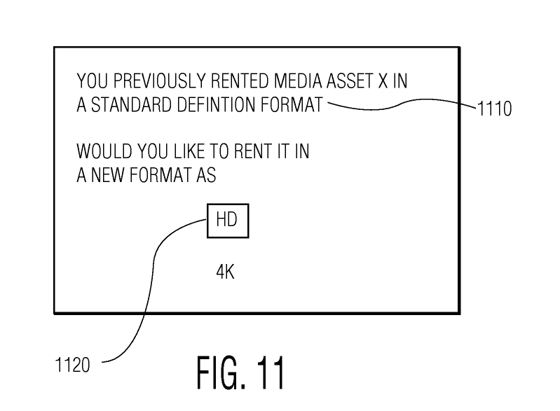

FIG. 11 presents an optional embodiment of a user interface 1100 that provides a user with the selections to upgrade a media asset that was previously provided in one format into a higher quality video format. Specifically, a user is notified via user interface 1100 that a media asset “x” has been previously rendered in a standard definition format 1110. The user is then provided with an option to rent media asset “x” in either a high definition or 4K version using indicator 1120. In this example, 4K is not selected. It is noted that different video formats and audio formats can also be provided as alternative options in accordance with the disclosed exemplary principles.

1. A method for providing media assets comprising:
receiving data corresponding to a transaction for a first media asset for a user account; and
providing a second media asset that is a same class as the first asset when said first media asset has been at least one of previously rented and purchased for said user account.

2. The method of claim 1 further comprising notifying a user that the first media asset has been previously at least one of rented and purchased for said user account.

3. The method of claim 1 further comprising:
determining at least one media asset from a plurality of media assets which is the same class as that of said first media asset; and
supplying information that said at least one media asset can be selected by a user for as said second media asset.

4. The method of claim 1 where said providing is a transmission of said second media asset from a server.

5. The method of claim 1 further comprising determining whether said transaction is at least one of a rental of said first media asset and purchase of said first media asset.

6. The method of claim 1 where said second media asset is provided in response to user input selecting said second media asset.

7. The method of claim 1 where said class is at least one of a movie series, a television series, a remake of a television show, a remake of a movie, a content creator, and video game series.

8. The method of claim 1 where said class is least one of a standard definition version of a media asset, a high definition version of a media asset, and a 4K version of a media asset.

9. The method of claim 5 where said second media asset can only be provided if said first and second media asset are from the same class.

10. The method of claim 1 further comprising:
generating display data indicating a plurality of assets which are of the same class of said first media asset; and
receiving user input corresponding to a selection of said second media asset from said plurality of assets where second media asset is provided in view said user input.

11. The method of claim 1 where said transaction is at least one of a gift card for said first media asset, a gift certificate for said first media asset, an optical code for said first media asset, and an alphanumeric code for said first media asset.

12. The method of claim 1 where said providing stores a version of said second media asset in a digital locker.

13. The method of claim 1 where said first media asset is at least one of a video based media asset, audio based media asset, audio/video media asset, and a video game.

14. An apparatus for providing media assets comprising:
a network interface configured to receive data corresponding to a transaction for a first media asset for a user account; and
a processor configured to provide a second media asset that is a same class as the first asset when said first media asset has been at least one of previously rented and purchased for said user account.

15. The apparatus of claim 14 wherein the processor is configured to notify a user that the first media asset has been at least one of previously rented and purchased for said user account.

16. The apparatus of claim 14 wherein the processor is configured to determine at least one media asset from a plurality of media assets which is the same class as that of said first media asset; and
the processor is configured to supply information that said at least one media asset can be selected by a user for as said second media asset.

17. The method of claim 14 wherein the processor provides said second media asset by transmitting said second media asset from a server.

18. The apparatus of claim 14 wherein the processor is configured to determine whether said transaction is at least one of a rental of said first media asset and purchase of said first media asset.

19. The apparatus of claim 14 wherein said processor provides said second media asset in response to user input selecting said second media asset.

20. The apparatus of claim 14 wherein said class is at least one of a movie series, a television series, a remake of a television show, a remake of a movie, a content creator, and video game series.

21. The apparatus of claim 14 wherein said class is least one of a standard definition version of a media asset, a high definition version of a media asset, and a 4K version of a media asset.

22. The apparatus of claim 19 wherein said second media asset can only be provided if said first and second media asset are from the same class.

23. The apparatus of claim 14 wherein said processor is configured to generate display data indicating a plurality of assets which are of the same class of said first media asset; and said processor is configured to receive user input corresponding to a selection of said second media asset from said plurality of assets where second media asset is provided in view said user input.

24. The apparatus of claim 14 wherein said transaction is at least one of a gift card for said first media asset, a gift certificate for said first media asset, an optical code for said first media asset, and an alphanumeric code for said first media asset.

25. The apparatus of claim 14 wherein said processor provides said second media asset by storing a version of said second media asset in a digital locker.

26. The apparatus of claim 14 wherein said first media asset is at least one of a video based media asset, audio based media asset, audio/video media asset, and a video game.
